(19) United States
(12) Patent Application Publication
(10) Pub. No.: US 2008/0148275 A1
(43) Pub. Date: Jun. 19, 2008

(54) Efficient Order-Preserving Delivery of Concurrent Messages

(76) Inventors: Alexander Krits, Haifa (IL); Benjamin Mandler, Zichron Yaakov (IL); Roman Vitenberg, Haifa (IL)

Correspondence Address: IBM CORPORATION, T.J. WATSON RESEARCH CENTER, P.O. BOX 218, YORKTOWN HEIGHTS, NY, 10598, US

(21) Appl. No.: 11/554,119

(22) Filed: Oct. 30, 2006

(51) Int. Cl. G06F 9/46

(52) U.S. Cl. 719/313

(57) ABSTRACT

A computer-implemented method for communication includes receiving over a network multiple ordered sequences of messages. Multiple processing threads are allocated for processing the received messages. Upon receiving each new message from the network, an ordered sequence to which the new message belongs is identified. While there is at least one preceding message in the identified ordered sequence such that processing, using at least a first processing thread, of the at least one preceding message has not yet been completed, processing of the new message is deferred. Upon completion of the processing of the at least one preceding message using at least the first processing thread, a second processing thread is assigned to process the new message, and the new message is processed using the second processing thread.

### FIELD OF THE INVENTION

The present invention relates generally to communication among computer processes, and specifically to systems and methods for ordered delivery of messages among computers.

### BACKGROUND OF THE INVENTION

Distributed group communication systems (GCSs) enable applications to exchange messages within groups of processes in a cluster of computers. The GCS provides a variety of semantic guarantees, such as reliability, synchronization, and ordering, for the messages being exchanged. For example, in response to an application request, the GCS may ensure that if a message addressed to the entire group is delivered to one of the group members, the message will also be delivered to all other live and connected members of the group, so that group members can act upon received messages and remain consistent with one another.

Chockler et al. provide a useful overview of GCSs in “Group Communication Specifications: A Comprehensive Study,” ACM Computing Surveys 33:4 (December, 2001), pages 1-43. This paper focuses on view-oriented GCSs, which provide membership and reliable multicast services to the member processes in a group. The task of a membership service is to maintain a list of the currently-active and connected processes in the group. The output of the membership service is called a “view.” The reliable multicast services deliver messages to the current view members.

Various methods are known in the art for maintaining the desired message order in a GCS. Chiu et al. describe one such ordering protocol, for example, in “Total Ordering Group Communication Protocol Based on Coordinating Sequencers for Multiple Overlapping Groups,” Journal of Parallel and Distributed Computing 65 (2005), pages 437-447. Total ordering delivery, as described in this paper, is characterized by requiring that messages be delivered in the same relative order to each process. The protocol proposed by the authors is sequencer-based, i.e., sequencer sites are chosen to be responsible for ordering all multicast messages in order to achieve total ordering delivery.

### SUMMARY OF THE INVENTION

There is therefore provided, in accordance with an embodiment of the present invention, a computer-implemented method for communication, in which multiple ordered sequences (e.g., partially ordered sets) of messages are received over a network. Multiple processing threads are allocated for processing the received messages. Upon receiving each new message from the network, an ordered sequence to which the new message belongs is identified. While there is at least one preceding message in the identified ordered sequence such that processing, using at least a first processing thread, of the at least one preceding message has not yet been completed, processing of the new message is deferred. Upon completion of the processing of the at least one preceding message using at least the first processing thread, a second processing thread is assigned to process the new message, and the new message is processed using the second processing thread.

Other embodiments of the invention provide communication apparatus and computer software products.

The present invention will be more fully understood from the following detailed description of the embodiments thereof, taken together with the drawings in which:

### BRIEF DESCRIPTION OF THE DRAWINGS

FIG. 1 is a block diagram that schematically illustrates a cluster of computing nodes, in accordance with an embodiment of the present invention;

FIGS. 2A and 2B schematically illustrate directed acyclic graphs corresponding to sequences of messages, in accordance with an embodiment of the present invention;

FIG. 3 is a flow chart that schematically illustrates a method for processing a received message, in accordance with an embodiment of the present invention; and

FIG. 4 is a flow chart that schematically illustrates a method for ordered message processing, in accordance with an embodiment of the present invention.

### DETAILED DESCRIPTION OF EMBODIMENTS

FIG. 1 is a block diagram that schematically illustrates a cluster 20 of computing nodes 22 connected by a network 24, in accordance with an embodiment of the present invention. Each node comprises a computer processor 26 and a communications adapter 28, linking the node to the network. In this example, processors 26 run application software 30, which may be a distributed application, and communicate with one another using a group communication system (GCS) layer 32. Processors 26 typically comprise general-purpose computer processors, which are programmed in software to carry out the functions described hereinbelow. This software may be downloaded to nodes 22 in electronic form, over network 24, for example, or it may alternatively be provided on tangible media, such as optical, magnetic or electronic memory media.

In an exemplary embodiment, nodes 22 may comprise WebSphere® application servers, produced by IBM Corporation (Armonk, N.Y.), and GCS 32 comprises the DCS group communication component of the WebSphere architecture. DCS is described, for example, by Farchi et al., in “Effective Testing and Debugging Techniques for a Group Communication System,” Proceedings of the 2005 International Conference on Dependable Systems and Networks (DSN'05). DCS comprises a stack of multiple layers, including a virtual synchrony layer 34, an application interface layer 36, and a membership layer 38. Messages between instances of application 30 on different nodes 22 pass through application interface layer 36 and the appropriate synchrony layer 34 to an underlying transport module associated with communications adapter 28, and then back up through the same stack on the target node (s). Membership layer 38 keeps track of the current view members and handles view changes. Synchrony and application interface layers 34 and 36 are responsible for ensuring that incoming messages are processed in the proper order, as described hereinbelow.

When nodes 22 transmit and receive messages relating to events, the mechanisms described hereinbelow also ensure proper ordering of these messages relative to application messages. Such event messages are typically related to management and control of the GCS. Events of this sort may be generated, for example, when the view changes, when the current view is about to close, when a certain member is about to leave the view, or when a process is about to terminate. The term “message,” as used in the present patent application and in the claims, should therefore be understood as comprising not only application-related messages, but also messages that report events.

In alternative embodiments, the principles of the present invention, and specifically the methods described hereinbelow, may be implemented in group communication and messaging systems of other types, as well as in client-server communication environments.

Although GCS 32 is designed to maintain a certain relative ordering among multicast messages sent by different nodes in system 20, there is no assurance that application messages sent from one node to another over network 24 will arrive at the destination node in the order in which they were sent by the source node. Furthermore, for computational efficiency, it is desirable that application interface layer 36 process incoming messages concurrently, by assigning a different processing thread to process each new message (at least up to the number of threads supported by the resources of the process in question). On the other hand, when two (or more) messages are processed concurrently on different threads of the same node, application interface layer 36 may finish processing and deliver the later message to application 30 before it delivers the earlier message, even when communications adapter 28 received the messages in the correct order. This sort of situation could be avoided by allocating a single thread to process all messages received in a given communication session from a certain node or group of nodes, but this sort of approach adds overhead and limits reuse and optimal utilization of threads.

In some embodiments, to ensure that messages from one node to another are processed in the proper order, the appropriate synchrony layer 34 marks each outgoing message with a message identifier, such as a header or other tag. The identifier indicates the source of the message, e.g., the node and possibly the application or process on the node that sent the message. In most cases, the message identifier contains an indication of at least one preceding message in the ordered sequence to which the outgoing message belongs (or an indication that this is the first message in the sequence).

At the receiving node, application interface layer 36 immediately assigns a thread to process the message, as long as there is a thread available and there is no preceding message (wherein the term “message” includes events, as noted above) whose processing has not yet been completed in the sequence of messages to which this message belongs. In other words, each new message received from the network is processed by all stack layers that may update the ordered sequence for this message. As long as there is any preceding message in this sequence whose processing has not yet been completed, the application interface layer defers processing of the new message. When the processing of all preceding messages has been completed (as well as when no preceding messages—including events—are found), the application interface layer assigns a processing thread to process the new message. To avoid the computational cost of continually allocating new threads, the application interface layer may draw threads for message processing from an existing thread pool, using thread pooling techniques that are known in the art. The approach provides maximal possible concurrency in processing messages from different sources while ensuring that messages are passed to the receiving application in the order determined by the sending application and/or by other applicable factors.

System 20 may be configured to support various different ordering models, such as first-in-first-out (FIFO) ordering and causal ordering. The type of indication of the preceding message that the sending node inserts in the message identifier depends on the message ordering model that is to be enforced. For example, if a FIFO model is used, the indication may simply comprise a sequential message number. (In the case of a FIFO model, the layer that implements the ordering does not need to encode the directed acyclic graph (DAG) and pass it to the application layer, because the application layer can implicitly derive the ordering between consecutive messages from every source.) On the other hand, if causal ordering is used, the message identifier for a given message may indicate two or more predecessor messages whose processing must be completed before a thread is assigned to process the given message.

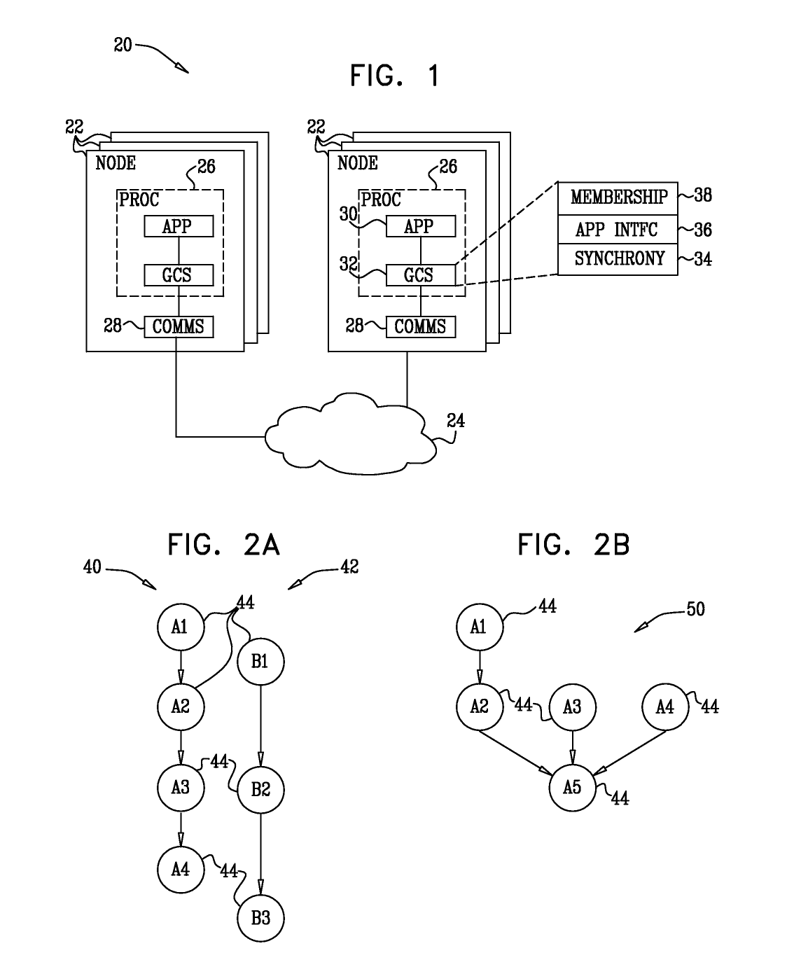

FIGS. 2A and 2B schematically illustrate sequences of messages 44 in system 20, which are represented by directed acyclic graphs (DAGs) 40, 42 and 50, in accordance with an embodiment of the present invention. Graphs 40 and 42 in FIG. 2A are characteristic of FIFO message ordering, whereas graph 50 in FIG. 2B represents a causal message ordering. Application interface layer 36 on the node that receives messages 44 uses these sorts of DAG representations to track message reception and processing, as described further hereinbelow.

Each message 44 has a source identifier (“A” or “B” in these examples) and a sequence number. As shown in FIG. 2A, ordered sequences of messages from sources A and B reach the application interface layer of the receiving node at different, interleaved times. The application interface layer at the receiving node may process the two sequences concurrently, using different threads. Each new message that arrives is added as a node (not to be confused with nodes 22) in the appropriate graph 40 or 42, with an edge pointing to the new message node from the preceding message node. In FIG. 2B, as a result of the causal ordering model, message A5 has multiple predecessors, A2, A3 and A4, which may be processed concurrently, but which must all be completed before message A5 is processed by the application interface layer. In general, it is not necessary for any given message to refer (using the message identifier tag mentioned above or using edges in the DAG) to all preceding messages in the sequence, but only to the immediate predecessors of the given message.

In each graph that represents an ordered message sequence, application interface layer 36 maintains a DAG window containing the messages that have been received and passed for delivery by the underlying layers in GCS 32 and whose processing has not yet been completed by layer 36. When processing of a message is completed, the message is deleted from the window. Layer 36 defines a “candidate frontier,” which comprises the messages in the DAG window that have no incoming edges in the window, e.g., the messages whose predecessors have all been processed, or which had no predecessors to begin with. Assuming graphs 40, 42 and 50 to represent the DAG windows of the corresponding message sequences, for example, the candidate frontiers comprise messages A1 and B1 in graphs 40 and 42, respectively, and messages A1, A3 and A4 in graph 50. The application interface layer processes the messages at the candidate frontier as described hereinbelow.

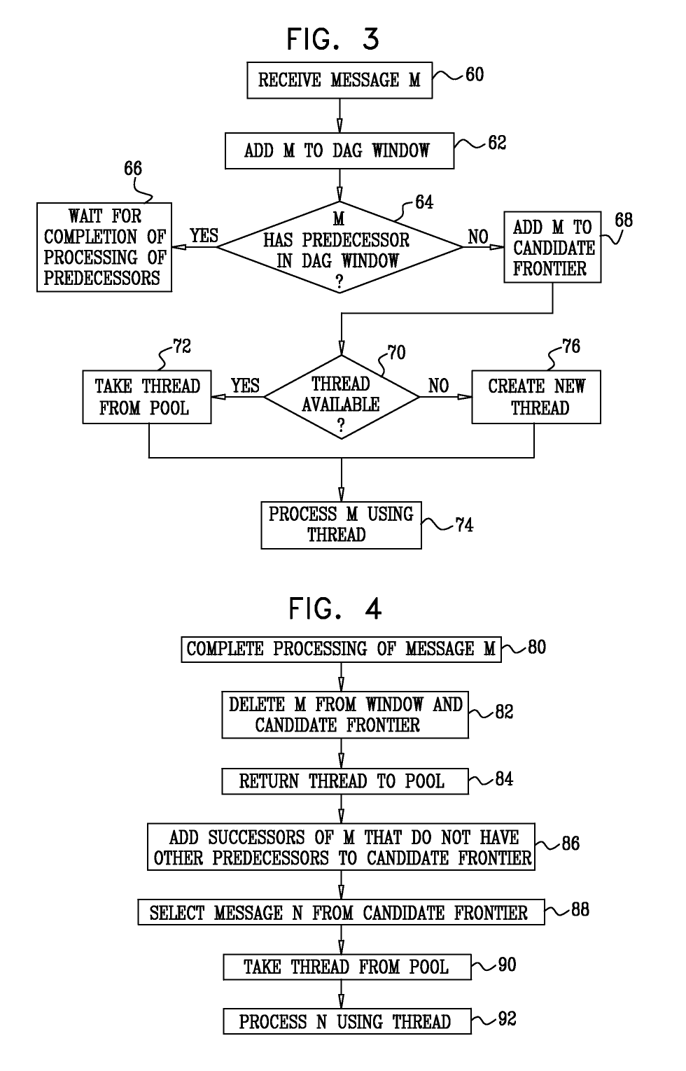

FIG. 3 is a flow chart that schematically illustrates a method for processing incoming messages that are received by application interface layer 36, in accordance with an embodiment of the present invention. The method is initiated whenever layer 36 receives a new message M from network 24, at a message reception step 60. The new message is added to the DAG window, at a DAG addition step 62. Typically, the underlying layers in GCS 32 ensure all messages are delivered to layer 36 in the proper order.

Layer 36 then ascertains whether M has any direct predecessors in the DAG window, at a predecessor checking step 64. If so, layer 36 adds one or more edges to the DAG, pointing from the direct predecessors to M. Further processing of M is deferred until processing of all the predecessors in the DAG window has been completed, at a deferral step 66. Subsequent processing of this message proceeds as described below with reference to FIG. 4.

If application interface layer 36 determines at step 64 that message M has no predecessors in the DAG window, it adds M to the candidate frontier, at a candidate addition step 68. Layer 36 then determines whether there is a thread available to process M, at an availability checking step 70. In this example, it is assumed that the process in question has a pool of threads that may be used for this purpose. If a thread is available in the pool, layer 36 takes a thread, at a thread assignment step 72, using standard thread pooling techniques, as are known in the art. It then uses this thread to process M, at a message processing step 74.

Otherwise, if there are no threads available in the pool at step 70, layer 36 may create a new thread to process M, at a thread creation step 76, as long as the number of active threads has not yet reached the concurrency limit of the process. If the number of active threads has reached the limit, and there are no free threads in the thread pool, layer 36 waits to process M until processing of another message is completed, and a thread becomes available in the thread pool, as described hereinbelow.

FIG. 4 is a flow chart that schematically illustrates a method for ordered processing of messages waiting in the DAG window of application interface layer 36, in accordance with an embodiment of the present invention. This method is initiated when layer 36 finishes processing a given message (again referred to as message M), at a message completion step 80. M is deleted from the DAG window and from the candidate frontier, at a message deletion step 82. The thread that was used to process M is released, and if there are no other messages eligible to be delivered, the thread is returned to the thread pool, at a thread release step 84.

Removal of M from the DAG window means that direct successors of M may no longer have a predecessor in the DAG window. Application interface layer 36 checks these successors, at a successor checking step 86, and adds to the candidate frontier any of the successor messages that no longer have any predecessors in the DAG window. Layer 36 then selects a message N from the candidate frontier for processing, at a next message selection step 88. To ensure that message sequences from all sources receive their fair share of the processing resources, layer 36 may choose the next message to process by random selection, round robin, or any other fair queuing scheme (including weighted schemes, if applicable). Layer 36 takes a thread from the pool, at a thread assignment step 90, and uses the thread to process message N, at a message processing step 92. When processing is completed, the thread is returned to the pool at step 80, and the cycle continues.

Although methods of ordered message processing are described above, for the sake of clarity, in the context of GCS in system 20, the principles of the present invention are similarly applicable, mutatis mutandis, in other computer communication environments. For example, the methods described above may be implemented on a server that serves multiple clients, in order to facilitate concurrent processing of messages from different clients while still ensuring that the messages from each client are processed in the properly-ordered sequence.

It will thus be appreciated that the embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. A computer-implemented method for communication, comprising:
receiving over a network multiple ordered sequences of messages;
allocating multiple processing threads for processing the received messages;
upon receiving each new message from the network, identifying an ordered sequence to which the new message belongs;
while there is at least one preceding message in the identified ordered sequence such that processing, using at least a first processing thread, of the at least one preceding message has not yet been completed, deferring processing of the new message;
upon completion of the processing of the at least one preceding message using at least the first processing thread, assigning a second processing thread to process the new message; and
processing the new message using the second processing thread.

2. The method according to claim 1, wherein allocating the multiple processing threads comprises assigning a plurality of the processing threads respectively to process the messages in different ones of the ordered sequences concurrently.

3. The method according to claim 1, wherein allocating the multiple processing threads comprises providing a thread pool, and wherein assigning the second processing thread comprises taking one of the threads from the thread pool.

4. The method according to claim 3, and comprising returning the first processing thread to the thread pool upon the completion of the processing of the at least one preceding message.

5. The method according to claim 1, and comprising, when there is no preceding message in the identified ordered sequence such that processing of the preceding message has not yet been completed, assigning one of the processing threads to process the new message without deferring the processing of the new message as long as not all of the processing threads are already in use.

6. The method according to claim 5, wherein assigning the one of the processing threads comprises assigning a plurality of the processing threads respectively to process the messages in different ones of the ordered sequences concurrently up to a maximal number of the processing threads that are available.

7. The method according to claim 1, wherein each of the messages is tagged with a message identifier that indicates a source of the message and contains an indication of the at least one preceding message in the ordered sequence to which the message belongs.

8. The method according to claim 1, wherein the ordered sequence is subject to first-in-first-out (FIFO) ordering, such that the new message has a single direct predecessor message, and wherein deferring the processing comprises waiting to process the new message until the single direct predecessor message has been processed.

9. The method according to claim 1, wherein the ordered sequence is subject to causal ordering, such that the new message has a set of multiple predecessor messages, and wherein deferring the processing comprises waiting to process the new message until all the predecessor messages in the set have been processed.

10. The method according to claim 1, wherein deferring the processing comprises maintaining a respective directed acyclic graph (DAG) corresponding to each of the ordered sequences, such that for each new message, a node corresponding to the new message is added to the DAG corresponding to the identified ordered sequence and, when processing of the at least one preceding message in the identified ordered sequence has not yet been completed, at least one edge is added to the DAG connecting the node to at least one preceding node corresponding to the at least one preceding message, and
wherein assigning the processing thread comprises assigning the thread to process the new message when there are no nodes preceding the node corresponding to the new message in the DAG that have not yet been processed.

11. The method according to claim 1, wherein receiving the multiple ordered sequences of messages comprises exchanging the messages among network nodes in a group communication system (GCS), and wherein at least one of the messages in the identified ordered sequence reports an event in the GCS.

12. A communication apparatus, comprising:
a communications adapter, which is arranged to be coupled to a network so as to receive multiple ordered sequences of messages; and
a process, which is arranged to allocate multiple processing threads for processing the received messages, and which is arranged, upon receiving each new message from the network, to identify an ordered sequence to which the new message belongs, and to defer processing of the new message while there is at least one preceding message in the identified ordered sequence such that processing, using at least a first processing thread, of the at least one preceding message has not yet been completed, and to assign a second processing thread to process the new message upon completion of the processing of the at least one preceding message using at least the first processing thread, and to process the new message using the second processing thread.

13. The apparatus according to claim 12, wherein the process is arranged to assign a plurality of the processing threads respectively to process the messages in different ones of the ordered sequences concurrently.

14. The apparatus according to claim 12, wherein the process is arranged to maintain a thread pool, and to take at least the first and second processing threads from the thread pool.

15. The apparatus according to claim 12, wherein the process is arranged, when there is no preceding message in the identified ordered sequence such that processing of the preceding message has not yet been completed, to assign one of the processing threads to process the new message without deferring the processing of the new message.

16. A computer software product, comprising a computer-readable medium in which program instructions are store, which instructions, when read by a computer that is coupled to a network so as to receive multiple ordered sequences of messages, cause the computer to allocate multiple processing threads for processing the received messages, and cause the computer, upon receiving each new message from the network, to identify an ordered sequence to which the new message belongs, and to defer processing of the new message while there is at least one preceding message in the identified ordered sequence such that processing, using at least a first processing thread, of the at least one preceding message has not yet been completed, and to assign a second processing thread to process the new message upon completion of the processing of the at least one preceding message using at least the first processing thread, and to process the new message using the second processing thread.

17. The product according to claim 16, wherein the instructions cause the computer to assign a plurality of the processing threads respectively to process the messages in different ones of the ordered sequences concurrently.

18. The product according to claim 16, wherein the instructions cause the computer to maintain a thread pool, and to take at least the first and second processing threads from the thread pool.

19. The product according to claim 18, wherein the instructions cause the computer to return the first processing thread to the thread pool upon the completion of the processing of the at least one preceding message.

20. The product according to claim 16, wherein the instructions cause the computer, when there is no preceding message in the identified ordered sequence such that processing of the preceding message has not yet been completed, to assign one of the processing threads to process the new message without deferring the processing of the new message.
